(19) United States
(12) Patent Application Publication
(10) Pub. No.: US 2019/0074029 A1
(43) Pub. Date: Mar. 7, 2019

(54) VOICE DATA PROCESSING APPARATUS AND VOICE DATA PROCESSING METHOD FOR AVOIDING VOICE DELAY

(71) Applicant: SAMSUNG SDS CO., LTD., Seoul (KR)

(72) Inventors: Sang-Bum KIM, Seoul (KR); Sang-Bum CHO, Seoul (KR); Jun-Ho KANG, Seoul (KR); Seong-Hun SHIN, Seoul (KR); Hee-Tae YOON, Seoul (KR)

(73) Assignee: SAMSUNG SDS CO., LTD., Seoul (KR)

(21) Appl. No.: 16/119,608

(22) Filed: Aug. 31, 2018

(30) Foreign Application Priority Data
Sep. 1, 2017 (KR) 10-2017-0111847

(51) Int. Cl. G10L 25/78; G10L 21/043; G10L 15/22; G10L 15/04

(52) U.S. Cl. CPC G10L 25/78; G10L 15/04; G10L 15/22; G10L 21/043

(57) ABSTRACT

Provided is an apparatus and method for processing voice data. The voice data processing apparatus according to an embodiment of the present disclosure includes: a data receiver configured to receive voice data; a storage configured to store the received voice data in a buffer; a section classifier configured to divide the stored voice data into one or more sections, and to classify each of the one or more sections as a voice section or a silent section; and a voice outputter configured to drop voice data classified as the silent section, or to output the voice data classified as the silent section by accelerating a playback speed.

### CROSS-REFERENCE TO RELATED APPLICATION(S)

This application claims priority from Korean Patent Application No.10-2017-0111847, filed on Sep. 1, 2017, in the Korean Intellectual Property Office, the entire disclosure of which is incorporated herein by reference for all purposes.

### BACKGROUND

### 1. Field

Embodiments of the present disclosure relate to a voice data processing apparatus and voice data processing method for avoiding a voice delay.

### 2. Description of the Related Art

Generally, devices for receiving voice through a network and outputting the voice in real time (e.g., voice streaming device, Voice over Internet Protocol (VoIP) device, etc.) may not smoothly output voice data if problems, such as packet loss, packet delay, and the like, occur.

In order to solve such problems, there have been developed techniques for storing the received voice data in a jitter buffer and outputting the voice data when an amount of the voice data stored in the jitter buffer is more than a predetermined amount.

However, there is still a problem in that in the event of occurrence of excessive delays, such as a delay caused by an overload on a transmitting device or a receiving device (e.g., delay due to an overload on a Central Processing Unit (CPU) of a computer at a transmitting end or a receiving end), a delay due to a network environment, or the like, voice data still cannot be output smoothly.

### SUMMARY

Embodiments of the present disclosure relate to technology for outputting voice data smoothly by avoiding a voice delay without compromising the quality of sound.

According to an aspect of the present disclosure, there is provided a voice data processing apparatus including: a data receiver configured to receive voice data; a storage configured to store the received voice data in a buffer; a section classifier configured to divide the stored voice data into one or more sections, and to classify each of the one or more sections as a voice section or a silent section; and a voice outputter configured to drop voice data classified as the silent section, or to output the voice data classified as the silent section by accelerating a playback speed.

The voice data processing apparatus may further include a voice delay determiner configured to determine whether a voice delay occurs by comparing a size of the stored voice data with a predetermined reference value, wherein in response to determination by the voice delay determiner that the voice delay occurs, the voice outputter may drop the voice data classified as the silent section or may output the voice data classified as the silent section by accelerating the playback speed.

The voice data processing apparatus may further include a silent section measurer configured to measure a duration of the silent section, wherein in response to the duration of the silent section exceeding a predetermined first reference time and a predetermined second reference time, the voice outputter may drop the voice data classified as the silent section.

The voice data processing apparatus may further include a silent section measurer configured to measure a duration of the silent section, wherein in response to the duration of the silent section exceeding the predetermined first reference time but being equal to or less than the predetermined second reference time, the voice outputter may output the voice data classified as the silent section by accelerating the playback speed.

According to another aspect of the present disclosure, there is provided a voice data processing method including: receiving voice data; storing the received voice data in a buffer; dividing the stored voice data into one or more sections; classifying each of the one or more sections as a voice section or a silent section; and dropping the voice data classified as the silent section, or outputting the voice data classified as the silent section by accelerating a playback speed.

The voice data processing method may further include, prior to the outputting, determining whether a voice delay occurs by comparing a size of the stored voice data with a predetermined reference value, wherein in response to determination that the voice delay occurs, the outputting may include dropping the voice data classified as the silent section or outputting the voice data classified as the silent section by accelerating the playback speed.

The voice data processing method may further include, prior to the outputting, measuring a duration of the silent section, wherein in response to the duration of the silent section exceeding a predetermined first reference time and a predetermined second reference time, the outputting may include dropping the voice data classified as the silent section.

The voice data processing method may further include, prior to the outputting, measuring a duration of the silent section, wherein in response to the duration of the silent section exceeding the predetermined first reference time but being equal to or less than the predetermined second reference time, the outputting may include outputting the voice data classified as the silent section by accelerating the playback speed.

### BRIEF DESCRIPTION OF THE DRAWINGS

FIG. 1 is a block diagram illustrating a voice data processing system according to an embodiment of the present disclosure.

FIG. 2 is a block diagram illustrating a voice data processing apparatus according to an embodiment of the present disclosure.

FIG. 3 is a block diagram illustrating a voice data processing apparatus according to another example of the present disclosure.

FIG. 4 is a flowchart illustrating an operation of a voice data processing apparatus according to an embodiment of the present disclosure.

FIGS. 5A and 5B are diagrams illustrating a voice section and a silent section according to an embodiment of the present disclosure.

FIG. 6 is a flowchart illustrating a voice data processing method performed by a voice data processing apparatus according to an embodiment of the present disclosure.

FIG. 7 is a block diagram illustrating an example of a computing environment which includes a computing device suitable for use in exemplary embodiments.

### DETAILED DESCRIPTION

Hereinafter, embodiments of the present disclosure will be described in detail with reference to the accompanying drawings. The following detailed description is provided for comprehensive understanding of methods, devices, and/or systems described herein. However, the methods, devices, and/or systems are merely examples, and the present disclosure is not limited thereto.

In the following description, a detailed description of well-known functions and configurations incorporated herein will be omitted when it may obscure the subject matter of the present disclosure. Further, the terms used throughout this specification are defined in consideration of the functions of the present disclosure, and can be varied according to a purpose of a user or manager, or precedent and so on. Therefore, definitions of the terms should be made on the basis of the overall context. It should be understood that the terms used in the detailed description should be considered in a description sense only and not for purposes of limitation. Any references to singular may include plural unless expressly stated otherwise. In the present specification, it should be understood that the terms, such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

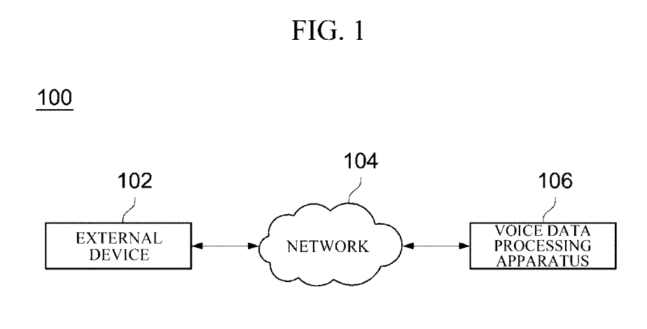

FIG. 1 is a block diagram illustrating a voice data processing system 100 according to an embodiment of the present disclosure.

Referring to FIG. 1, the voice data processing system 100 according to an embodiment of the present disclosure may be a system in which an external device 102 transmits input or generated voice data to a voice data processing apparatus 106 through a network 104, and the voice data processing apparatus 106 outputs the voice data in real time.

The external device 102 is a device for receiving voice data from a user and transmitting the voice data to the voice data processing apparatus 106 through the network 104, or a device for transmitting pre-generated voice data to the voice data processing apparatus 106. Examples of the external device 102 may include a mobile device, such as a laptop computer, a tablet PC, a smartphone, a PDA, and the like, a Voice over Internet Protocol (VoIP) device, a streaming server, and the like.

The network 104 is a communication network through which voice data is transmitted, and may be a wired or wireless network such as the Internet, one or more local area networks, wire area networks, cellular networks, mobile networks, and the like.

The voice data processing apparatus 106 may receive voice data from the external device 102 through the network 104, and may output the received voice data. Specifically, the voice data processing apparatus 106 may smoothly output the voice data without compromising the voice quality or without causing any voice delay by dropping a portion of the received voice data or by adjusting the playback speed of the voice data.

Further, the voice data processing apparatus 106 may store the voice data in a buffer in the order in which the voice data are generated by referring to a sequence number and the like of the received data packets, and may output the stored voice data in the order the voice data are stored in the buffer. Accordingly, even when the packets, transmitted sequentially by the external device 102, are received out of sequence by the voice data processing apparatus 106, the voice data processing apparatus 106 may output the received voice data in the order in which the voice data are generated.

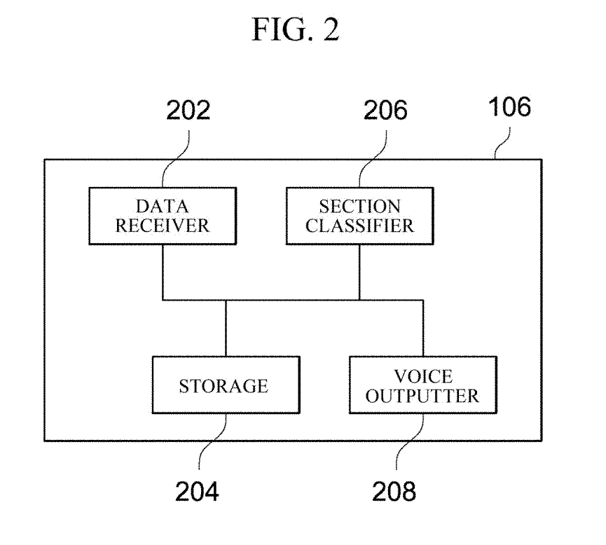

FIG. 2 is a block diagram illustrating a voice data processing apparatus 106 according to an embodiment of the present disclosure.

Referring to FIG. 2, the voice data processing apparatus 106 includes a data receiver 202, a storage 204, a section classifier 206, and a voice outputter 208.

The data receiver 202 receives voice data. Specifically, the data receiver 202 may receive voice data in units of packets from the external device 102 through the network 104.

The storage 204 may store the voice data received by the data receiver 202 in a buffer. In this case, the buffer is provided for temporarily storing the voice data received by the data receiver 202 until the voice data is output, and the buffer may be, for example, a jitter buffer. For example, the voice data stored in the buffer by the storage 204 may be dropped or output by the voice outputter 208 and may be deleted from the buffer.

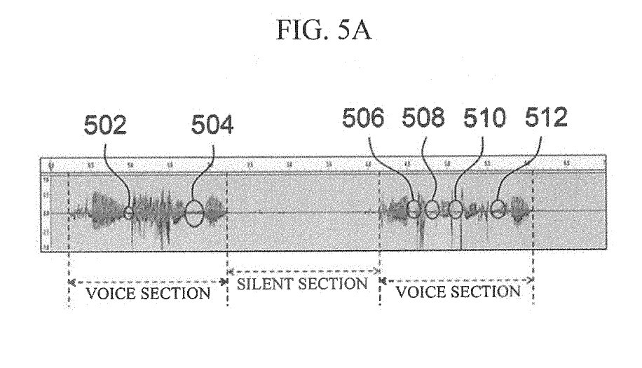

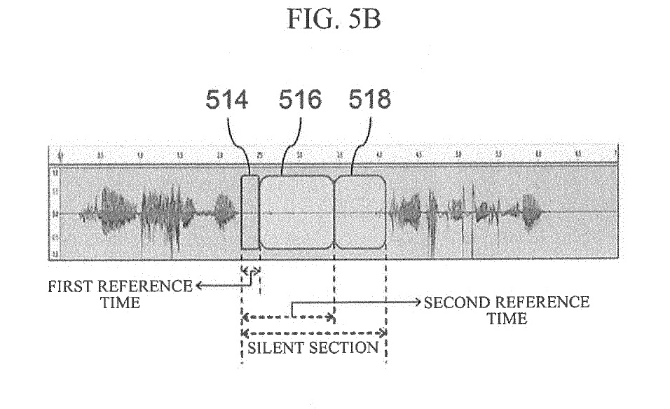

Specifically, the storage 204 may sequentially store the voice data, which are received in units of packets by the data receiver 202, in the order in which the voice data are generated. For example, the storage 204 may store the packets in the buffer in the order in which the voice data are generated, by referring to a sequence number or a timestamp of the received packets. The section classifier 206 may divide the voice data, stored in the buffer by the storage 204, into one or more sections, and may classify the one or more sections as a voice section or a silent section. In this case, the voice section may refer to a section in which a user's voice exists among the entire sections of the voice data; and the silent section may refer to a section in which a user's voice does not exist (e.g., a section in which a user stops talking) among the entire sections of the voice data, which will be described in detail with reference to FIG. 5.

Specifically, the section classifier 206 may divide the voice data, stored in the buffer, into several sections each having a predetermined length, and may sequentially classify the sections as the voice section or the silent section, starting from a section having first generated voice data. In this case, the predetermined length may be a length of a section which is preset by a user, and may be, for example, 10 ms.

For example, in the case where voice data having a length of 0 ms to 500 ms are stored in the buffer, the section classifier 206 may divide the voice data stored in the buffer into 50 sections each having a length of 10 ms. Further, the section classifier 206 may sequentially classify the sections as the voice section or the silent section, starting from a section having first generated voice data (e.g., a section of 0 ins to 10 ms).

If a portion of the voice data in a section to be classified by the section classifier 206 does not exist (e.g., in the case where voice data in a section of 0 ms to 10 ms is transmitted through the network 104 but voice data in a section of 3 ms to 5 ms is not received due to packet loss and the like), the section classifier 206 may wait for data in the section (e.g., voice data in the section of 3 ms to 5 ms) to be stored in the buffer, or may exclude the data in the section and may classify the remaining sections (e.g., a section of 0 ms to 3 ms and a section of 5 ms to 10 ms) into the voice section or the silent section.

In this case, the section classifier 206 may classify the one or more sections as the voice section or the silent section by calculating a speech probability by analyzing, for example, a spectrum of voice data, or by applying a Voice Activity Detection (VAD) method based on normal distribution of audio intensity of voice data.

The voice outputter 208 may drop the voice data classified as the silent section by the section classifier 206, or may output the voice data classified as the silent section by accelerating the playback speed of the voice data. Further, the voice outputter 208 may output the voice data as they are, which are classified as the voice section by the section classifier 206.

For example, in the case where the section of 0 ms to 3000 ms is classified as the voice section and the section of 3000 ms to 5000 ms is classified as the silent section by the section classifier 206 among the voice data stored in the buffer, the voice outputter 208 may output the voice data in the section of 0 ms to 3000 ms as they are, and may drop the voice data in the section of 3000 ms to 5000 ms or may output the voice data in the section of 3000 ms to 5000 ms by accelerating the playback speed (e.g., accelerating the playback speed by 1.5 times) of the voice data.

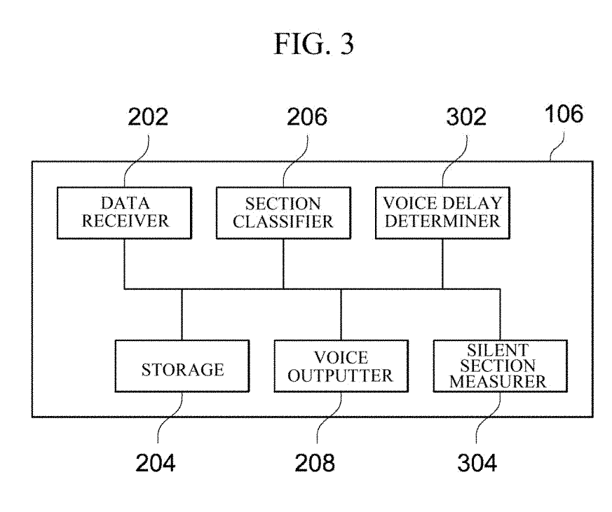

FIG. 3 is a block diagram illustrating another example of a voice data processing apparatus 106 according to another example of the present disclosure. The components of FIG. 2 are illustrated in FIG. 3 with the same reference numerals, and the description of details overlapping with those described above will be omitted.

Referring to FIG. 3, the voice data processing apparatus 106 may further include a voice delay determiner 302 and a silent section measurer 304.

The voice delay determiner 302 may determine whether a voice delay occurs by comparing the size of voice data stored in the buffer with a predetermined reference value. In this case, the predetermined reference value may be a value set within a range of the size of a jitter buffer in order to compensate for jitter, which is the variation in packet arrival times caused by packet delay between a transmitting end and a receiving end during packet transmission. In this case, if the predetermined reference value is excessively increased, end-to-end delay is increased, and if the predetermined reference value is excessively decreased, a packet drop probability is increased, such that the reference value should be set properly by considering both the end-to-end delay and the packet drop. In addition, the predetermined reference value may be changed by considering a variable network delay or a burst rate of received packets. Specifically, in the case where the size of voice data stored in the buffer exceeds a predetermined reference value, the voice delay determiner 302 may determine that a voice delay occurs.

In this case, upon determining by the voice delay determiner 302 that a voice delay occurs, the voice outputter 208 may drop the voice data classified as the silent section by the section classifier 206, or may output the voice data classified as the silent section by accelerating the playback speed of the voice data.

By contrast, upon determining by the voice delay determiner 302 that a voice delay does not occur, the voice outputter 208 may output the voice data as they are, which are classified as the silent section or the voice section by the section classifier 206.

The silent section measurer 304 may measure a duration of the silent section. In this case, the duration of the silent section may refer to a period of time during which the silent section continues.

Specifically, the silent section measurer 304 may measure a duration of the silent section by using a classification result of the section classifier 206. For example, in the case where the section classifier 206 continuously classifies sections subsequent to a section of 500 ms as the silent section, and the section classifier 206 currently classifies a section of 1000 ms to 1010 ms as the silent section, the silent section measurer 304 may measure the current duration of the silent section to be 510 ms.

Further, in the case where the section classifier 206 classifies a certain section as the voice section, the silent section measurer 304 may initialize a duration of the silent section to 0. For example, in the case where the section classifier 206 continuously classifies sections subsequent to a section of 500 ms as the silent section, but the section classifier 206 currently classifies a section of 1000 ms to 1010 ms as the voice section, the silent section measurer 304 may initialize a duration of the silent section to 0.

In the case where a duration of the silent section exceeds a predetermined first reference time and a predetermined second reference time, the voice outputter 208 may drop voice data classified as the silent section by the section classifier 206. In this case, the first reference time may be a time predetermined to maintain a short silent section present between voice sections. Specifically, in the case where voice data in a short silent section (e.g., when a user speaks one sentence, a silent section generated due to the spacing between words in a sentence, etc.) between voice sections are dropped, the first reference time may be set properly to avoid awkwardness that may be felt by a listener of the voice data, and may be set to, for example, 500 ms. Further, the second reference time may be a time predetermined to maintain the silent section present between voice sections for a predetermined period of time or longer. Specifically, in the case where the silent section between voice sections is excessively decreased (e.g., when voice data determined to be the silent section are all dropped), the second reference time may be set properly to avoid awkwardness that may be felt by a listener of the voice data, and may be set to, for example, 1000 ms. For example, the second reference time may be selected properly by accelerating the playback speed of voice data having a silent section that continues for a relatively short duration, and by dropping voice data having a silent section that continues for a relatively long duration.

Moreover, in the case where a duration of the silent section exceeds the predetermined first reference time but is equal to or less than the predetermined second reference time, the voice outputter 208 may output the voice data, which are classified as the silent section by the section classifier 206, by accelerating the playback speed of the voice data.

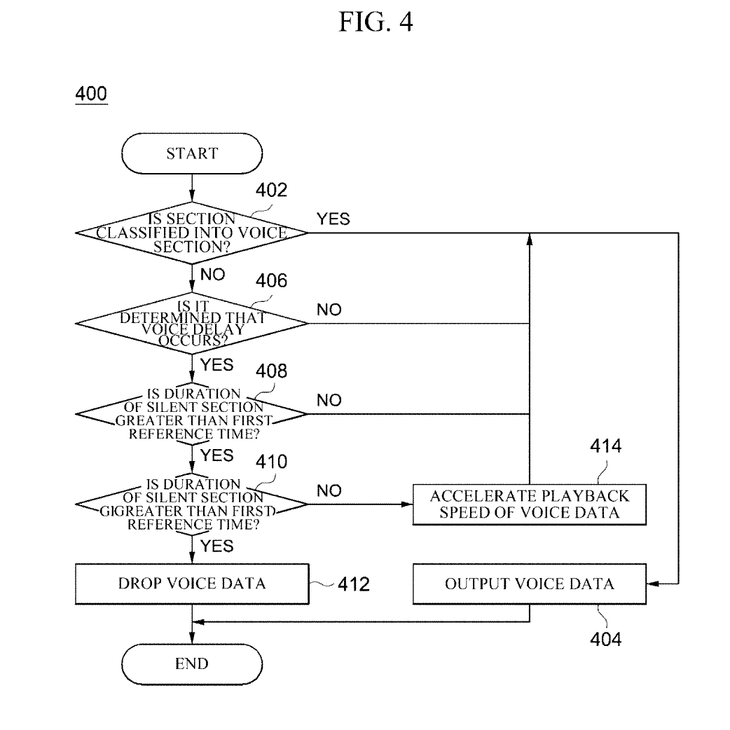

FIG. 4 is a flowchart 400 illustrating an operation of a voice data processing apparatus 106 according to an embodiment of the present disclosure.

Referring to FIG. 4, the voice data processing apparatus 106 may divide voice data, stored in a buffer, into one or more sections, and may classify each of the sections as a voice section or a silent section in 402. In the case where a section is classified as the voice section, the voice data processing apparatus 106 may output the voice data in the classified section as they are in 404.

By contrast, in the case where a section is classified as the silent section, the voice data processing apparatus 106 may determine whether a voice delay occurs in 406. Upon determining that the voice delay does not occur, the voice data processing apparatus 106 may output the voice data in the classified section as they are in 404.

However, upon determining that the voice delay occurs, the voice data processing apparatus 106 may determine whether a duration of the silent section exceeds a first reference time in 408. In response to the duration of the silent section not exceeding the first reference time, the voice data processing apparatus 106 may output the voice data in the classified section as they are in 404.

By contrast, in response to the duration of the silent section exceeding the first reference time, the voice data processing apparatus 106 may determine whether the duration of the silent section exceeds the second reference time in 410. In response to the duration of the silent time not exceeding the second reference time, the voice data processing apparatus 106 may output the voice data in the classified section by accelerating the playback speed of the voice data in 414 and 404.

However, in response to the duration of the silent section exceeding the second reference time, the voice data processing apparatus 106 may drop the voice data in the classified section in 412.

FIGS. 5A and 5B are diagrams illustrating a voice section and a silent section according to an embodiment of the present disclosure.

Referring to FIG. 5A, the voice data processing apparatus 106 may classify each section of voice data as a voice section or a silent section by using information, for example, a spectrum and an audio intensity of the voice data.

Specifically, the voice data processing apparatus 106 may classify, as the voice section, a section in which a human voice exists and short silent sections (502 to 512) present between sections in which the voice exists.

Referring to FIG. 5B, the voice data processing apparatus 106 may drop voice data in the silent section, or play output the voice data by accelerating the playback speed of the voice data.

In the case where the voice data belongs to the silent section, and a duration of the silent section is equal to or less than a first reference time in 514, the voice data processing apparatus 106 may output the voice data as they are without changing the playback speed of the voice data. Further, in the case where the voice data belongs to the silent section, and a duration of the silent section exceeds the first reference time but is equal to or less than a second reference time in 516, the voice data processing apparatus 106 may output the voice data by accelerating the playback speed of the voice data. In addition, in the case where the voice data belongs to the silent section and a duration of the silent section exceeds the first reference time and the second reference time in 518, the voice data processing apparatus 106 may drop the voice data.

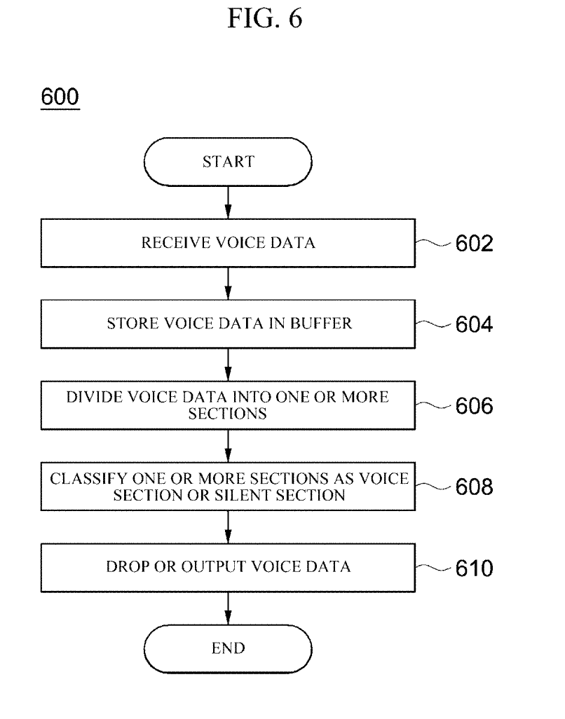

FIG. 6 is a flowchart 600 illustrating a voice data processing method performed by a voice data processing apparatus 106 according to an embodiment of the present disclosure.

Referring to FIG. 6, the voice data processing apparatus 106 according to an embodiment of the present disclosure receives voice data in 602.

The voice data processing apparatus 106 stores the received voice data in a buffer in 604.

The voice data processing apparatus 106 divides the voice data, stored in the buffer, into one or more sections in 606.

The voice data processing apparatus 106 classifies each of the one or more sections as a voice section or a silent section in 608.

The voice data processing apparatus 106 may determine whether a voice delay occurs by comparing the size of the voice data stored in the buffer with a predetermined reference value.

The voice data processing apparatus 106 may measure a duration of the silent section.

The voice data processing apparatus 106 may drop the voice data classified as the silent section or may output the voice data classified as the silent section by accelerating the playback speed in 610. In this case, upon determining that a voice delay occurs, the voice data processing apparatus 106 may drop the voice data classified as the silent section, or may output the voice data classified as the silent section by accelerating the playback speed. Further, in response to a duration of the silent section exceeding the predetermined first reference time and the predetermined second reference time, the voice data processing apparatus 106 may drop the voice data classified as the silent section. Moreover, in response to a duration of the silent section exceeding the predetermined first reference time but being equal to or less than the predetermined second reference time, the voice data processing apparatus 106 may output the voice data classified as the silent section by accelerating the playback speed.

While the flowchart illustrated in FIG. 6 shows that the method is divided into a plurality of operations, at least some of the operations may be performed in different order, may be combined to be performed concurrently, may be omitted, may be performed in sub-operations, or one or more operations not shown in the drawing may be added and performed.

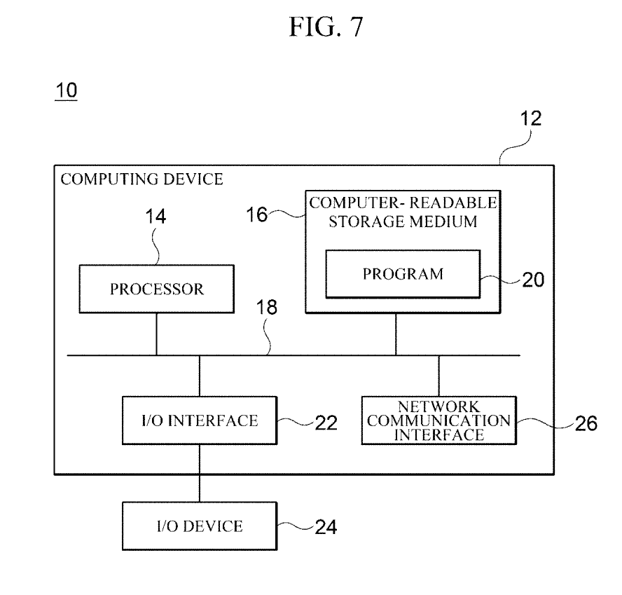

FIG. 7 is a block diagram illustrating an example of a computing environment which includes a computing device suitable for use in exemplary embodiments. In the illustrated embodiment, each component may have a different function or capability from those described below, and other components may be further included in addition to the components which will be described below.

The illustrated computing environment 1 includes a computing device 12. In one embodiment, the computing device 12 may be one or more components included in the voice data processing apparatus 106.

The computing device 12 includes at least one processor 14, a computer-readable storage medium 16, and a communication bus 18. The processor 14 may control the computing device 12 to operate according to the above-described exemplary embodiments. For example, the processor 14 may execute one or more programs stored on the computer-readable storage medium 16. The one or more programs may include one or more computer-executable instructions, which when being executed by the processor 14, may cause the computing device 12 to perform operations according to the exemplary embodiments.

The computer-readable storage medium 16 stores computer-executable instructions, program codes, program data, and/or other suitable forms of information. The programs 20 to stored on the computer-readable storage medium 16 may include a set of instructions executable by the processor 14. In one embodiment, the computer-readable storage medium 16 may be a memory (volatile or non-volatile memory such as a random access memory (RAM), or a suitable combination thereof), one or more magnetic disc storage devices, optical disk storage devices, flash memory devices, and other forms of storage media accessible by the computing device 12 and capable of storing desired information, or any suitable combination thereof.

The communication bus 18 interconnects various components of the computing device 12 including the processor 14 and the computer-readable storage medium 16.

The computing device 12 may further include one or more input/output (I/O) interfaces 22 which provide interfaces for one or more I/O devices 24, and one or more network communication interfaces 26. The I/O interface 22 and the network communication interface 26 are connected to the communication bus 18. The I/O device 24 may be connected to other components of the computing device 12 through the I/O interface 22. The illustrative I/O device 24 may include a pointing device (e.g., mouse, trackpad, etc.), a keyboard, a touch input device (e.g., touch pad, touch screen, etc.), a voice or sound input device, input devices such as various types of sensor devices and/or a photographing device, and/or output devices such as a display device, a printer, a speaker, and/or a network card. The illustrative I/O device 24 may be included in the computing device 12 as a component of the computing device 12, or may be connected to the computing device 12 as a separate device distinct from the computing device 12. According to embodiments of the present disclosure, voice data may be output smoothly by avoiding a voice delay without compromising the quality of sound.

Although representative embodiments of the present disclosure have been described in detail, it should be understood by those skilled in the art that various modifications to the aforementioned embodiments can be made without departing from the spirit and scope of the present disclosure. Thus, the scope of the present disclosure is not intended to be limited to the described embodiments, but should be defined by the appended claims and their equivalents.

What is claimed is:

1. A voice data processing apparatus comprising:
a data receiver configured to receive voice data;
a storage configured to store the received voice data in a buffer;
a section classifier configured to divide the stored voice data into one or more sections, and to classify each of the one or more sections as a voice section or a silent section; and
a voice outputter configured to drop voice data classified as the silent section, or to output the voice data classified as the silent section by accelerating a playback speed.

2. The apparatus of claim 1, further comprising a voice delay determiner configured to determine whether a voice delay occurs by comparing a size of the stored voice data with a predetermined reference value,
wherein in response to determination by the voice delay determiner that the voice delay occurs, the voice outputter drops the voice data classified as the silent section or outputs the voice data classified as the silent section by accelerating the playback speed.

3. The apparatus of claim 1, further comprising a silent section measurer configured to measure a duration of the silent section,
wherein in response to the duration of the silent section exceeding a predetermined first reference time and a predetermined second reference time, the voice outputter drops the voice data classified as the silent section.

4. The apparatus of claim 1, further comprising a silent section measurer configured to measure a duration of the silent section,
wherein in response to the duration of the silent section exceeding the predetermined first reference time but being equal to or less than the predetermined second reference time, the voice outputter outputs the voice data classified as the silent section by accelerating the playback speed.

5. A voice data processing method comprising:
receiving voice data;
storing the received voice data in a buffer;
dividing the stored voice data into one or more sections;
classifying each of the one or more sections as a voice section or a silent section; and
dropping the voice data classified as the silent section, or outputting the voice data classified as the silent section by accelerating a playback speed.

6. The method of claim 5, further comprising, prior to the outputting, determining whether a voice delay occurs by comparing a size of the stored voice data with a predetermined reference value,
wherein in response to determination that the voice delay occurs, the outputting comprises dropping the voice data classified as the silent section or outputting the voice data classified as the silent section by accelerating the playback.

7. The method of claim 5, further comprising, prior to the outputting, measuring a duration of the silent section,
wherein in response to the duration of the silent section exceeding a predetermined first reference time and a predetermined second reference time, the outputting comprises dropping the voice data classified as the silent section.

8. The method of claim 5, further comprising, prior to the outputting, measuring a duration of the silent section,
wherein in response to the duration of the silent section exceeding the predetermined first reference time but being equal to or less than the predetermined second reference time, the outputting comprises outputting the voice data classified as the silent section by accelerating the playback.
